(19) United States
(12) Patent Application Publication
(10) Pub. No.: US 2014/0304183 A1
(43) Pub. Date: Oct. 9, 2014

(54) Verification System

(71) Applicant: VERIF-Y, INC., Penn Valley, PA (US)

(72) Inventor: Ed Adi Zabar, Penn Valley, PA (US)

(73) Assignee: VERIF-Y, INC., Penn Valley, PA (US)

(21) Appl. No.: 14/231,852

(22) Filed: Apr. 1, 2014

Related U.S. Application Data
(60) Provisional application No. 61/809,200, filed on Apr. 5, 2013.

(51) Int. Cl. G06Q 50/26; G06Q 10/10

(52) U.S. Cl. CPC G06Q 50/265; G06Q 10/1053
USPC 705/321; 705/325

(57) ABSTRACT

In described embodiments, a verification system allows for registration of credential providing entities and storage of credential data from, and verified by, the credential providing entities. The verification system further allows for users, through a credential and verification device associated with the credential providing entities, to approve the use of corresponding credential data by those accessing the verification system. In some embodiments, on-going tracking of current requirements for maintaining certain credentials is performed. Employers or other interested parties might access the verification system to verify information of certain credentials, and lapses in maintenance of certain credentials. By definition herein, credential data includes qualifications to perform various duties or Job functions that arise from academic or trade institution awards and degrees, organizational certifications and training, and various work experience that is verifiable by a third party, institution, organization and/or employer.

### CROSS-REFERENCE TO RELATED APPLICATIONS

This application claims the benefit of the filing date of U.S. provisional application No. 61/809,200, filed on Apr. 5, 2013 as attorney docket no. 144897.010100, the teachings of which are incorporated herein by reference.

### BACKGROUND OF THE INVENTION

1. Field of the Invention

The present invention relates to verification systems, and, in particular, to verifying credentials of individuals.

2. Description of the Related Art

Increasingly, individuals engaged in various types of activities rely on raining and education to perform their duties. In addition to education, level of degree and courses taken, an individual continues to obtain certifications, peer-bestowed awards and professional licenses. Other forms of credentials exist, and together these credentials form an important part of an individual's personal and professional resume. Further, as an individual moves from an academic or trades education into the workforce, employment or other work experience adds to this resume. By definition, this resume of experience and credentials is a measure of an individual's qualifications to perform various duties or job functions. As employed herein, an individual is usually thought of as a person in the traditional sense, but might just as easily be applied to an entity such as a corporation, an educational or professional institution, or society.

Competition in today's society has unfortunately fostered an environment where an individual might misrepresent, or even fabricate, data representing the individual's resume, work experience, and particular qualifications. For example, an employer hiring an individual for an employment position might require a certain college or graduate degree, specific courses taken, or professional license as prerequisite for the position. An individual need only obtain original copy of a transcript or certificate, and then through desktop digital publishing create the papers to show the individual “meets” each prerequisite. Increasingly, services such as background checks are used to independently verify aspects of the individual's resume, but these are slow and expensive to perform on a case by case basis. To help prevent fraudulent degrees or certifications, some organizations have employed digital security, such as watermarks, codes and the like, to protect and provide a means of verification for their physically embodied documents or awards.

Millions of awards, academic credentials and other professional designations are forged every year all over the world. Potential employers, professional organizations, and others, review individuals' online and offline resumes, biographies and credentials every day with little to no knowledge of the scale and prevalence of these forgeries. The need to establish an authenticated online identity increases as our lives move increasingly into the digital world.

Even when memberships, awards or certifications are valid, these qualifications often require some form of periodic maintenance. For example, surgeons and nurses might require certain forms of ongoing certification to keep current, or may just simply require periodic payment to a professional society to maintain an active license to practice. However, satisfying these activities is usually the responsibility of the individual, and can often lapse by accident, lack of action, or other action. When this occurs, the employer often is unaware of the lapse, and few mechanisms are in place to inform others of these lapses. For the example of the surgeon's on-going certification, if this certification lapses and the individual continues to perform health-related services in a hospital, an insurance company might refuse to cover and compensate the hospital for the costs. In the case of a lawyer that might be subject to disciplinary action, temporarily or permanently disbarred, the individual can still be giving advice and so practicing law, but would not covered by professional liability insurance.

Further, contracts or assignments are usually bestowed based on cumulative experience. Merely working for a construction company does not necessarily mean that the individual has seasoned project management experience. However, an individual might “pad” his resume, taking credit for major aspects of past projects for which only minor activities were actually performed. Verification of aspects of employment and work history can be very challenging for potential employers.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention provides for verified digital information, the verified digital information relating to individual credential data, including: communicating, by a verification server, with at least one entity through a network, receiving credential information for a plurality of individuals, and storing the credential data in a database; registering an account for at least one individual of the plurality of individuals through an associated user device. The credential data is processed to form verified digital information. The verification server receives a request for authentication data relating to an individual, generating the requested, authentication data relating to the individual by the verification server from corresponding portions of the verified digital information in the database. The authentication data is generated in a secure format, and the requested, authentication data relating to the individual by the verification server is provided for display.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a verification system in accordance with an exemplary embodiment;

FIG. 2 shows an exemplary credential and verification device as might be employed by the exemplary embodiment of FIG. 1;

FIG. 3 shows alternative embodiments of exemplary credential and verification devices;

FIG. 4 shows an exemplary communication configuration for an individual as user for the verification system as shown in FIG. 1;

FIG. 5 shows a method of communication for verification as shown with the configuration of FIG. 4; and

FIG. 6 shows a method of populating a database and tracking renewal of verification data as might be employed by the verification system of FIG. 1.

### DETAILED DESCRIPTION

In accordance with exemplary embodiments, a verification system allows for registration of, storage of credential data from, and verification by, credential providing entities, as well as licensing entities. The verification system further allows for users, through a credential verification device associated with the credential providing entities, to register and/or approve the use of corresponding credential data by those accessing the verification system. Some embodiments might provide for a physical device, such as a label with a bar code, while other embodiments might provide a virtual device, such as user login or e-mail account. The credential data is processed to form verified digital information, which can be requested by those attempting to verify an individual's background, qualifications and employment, and verified digital information is displayed in a secure format. Requests for verified credential data might generate authentication data corresponding to an individual, also termed verification data, which is displayed on a device incorporating varying form of security.

In some embodiments, on-going tracking of current requirements for maintaining certain credentials is performed. Employers or other interested parties might access the verification system to provide employment or other work history information of individuals, as well as certain corresponding employer-supplied credentials. Employers or other interested parties might access the verification system to verify (authenticate) information of certain credentials, and lapses in maintenance of certain credentials. By definition herein, credential data includes qualifications to perform various duties or job functions that arise from academic or trade institution awards and degrees, organizational certifications and training, and various work experience that is verifiable by a third party, institution, organization and/or employer. Further examples of qualifications include sports-related participation or awards, charity affiliations, and government (including military) service information. As employed herein, an “individual” is generally described and used as a person in the traditional sense, but the present invention is not limited thereto. The term “individual” as employed herein might just as easily be applied to an entity such as a corporation, an educational or professional institution, society, and so forth.

Unlike prior attempts to provide verified documentation, a verification system in accordance with described embodiments displays the original documents from, for example, the awarding institute on a secure cloud platform where users are able to manage them and third parties are able to access them. Prior attempts show a PDF stating that the award is verified, but in many cases users still have to show the original documents provided by the awarding institute (e.g., university). A verification system in accordance with described embodiments shows a certified (original) copy of the award document (e.g., Diploma) as well as any adjacent documents (i.e. transcripts) in order to ensure that the awardee doesn't have to still show the original every time.

Described embodiments provide a proprietary and secure platform which enables a quick, secure verification process for diplomas, awards, ranks, certificates and any other forms of recognition of achievements. The System allows third parties to verify the authenticity of various Awards and avoid the current practice of either calling on the awarding organization, digging through old records to find a paper copy, paying for a lengthy background check or simply taking the Awardee's word for it. Potential employers, human resource (HR) professionals and others might be able to review resumes, bio's and credentials with an ability to quickly and securely verify their authenticity. The need to establish an authenticated online identity increases as we continue to move into the digital world, yet awards and credentials granted to individuals and organizations around the globe are not generally securely digitized and displayed online in an easily verified manner. Described embodiments make verified awards available in a secure online environment, allowing individuals to authentically present and share their awards in a more accessible and credible manner.

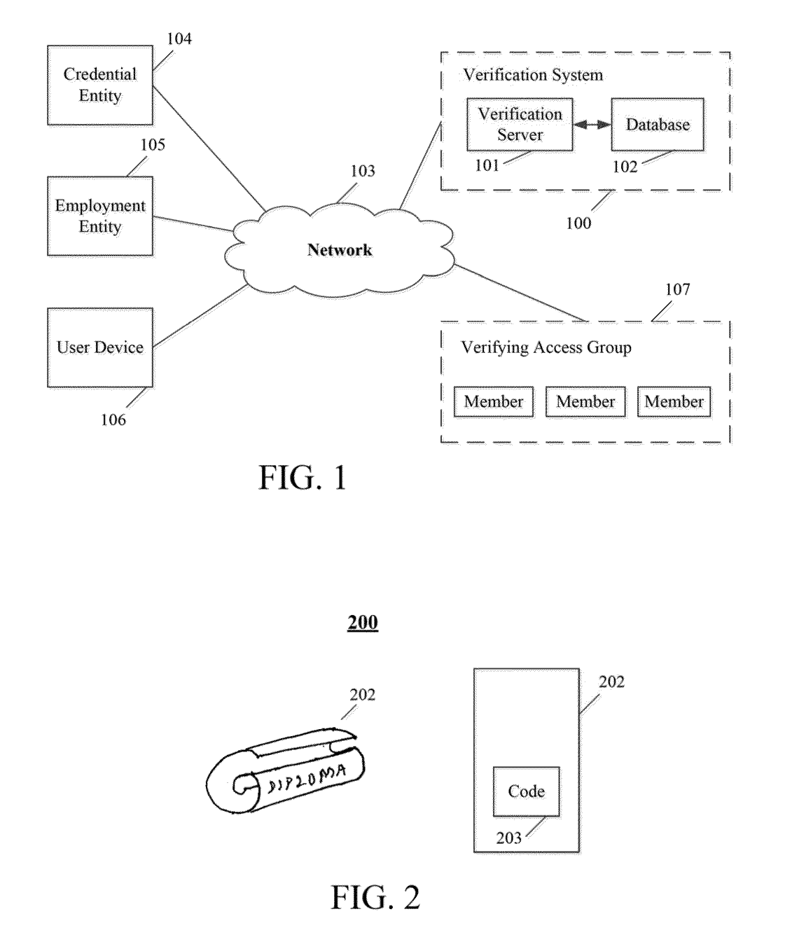

FIG. 1 shows a verification system in accordance with an exemplary embodiment. Verification system 100 comprises a verification server 101 coupled to database 102. Verification server 101 is also coupled to and in communication with network 103. Verification system 100 is further coupled to and in communication with credential entity 104 and employment entity 105. Through network 103, verification system 100 is coupled to, in communication with, and provides for operation with user device 106, which user might be associated in some manner with one or more of credential entity 104 and employment entity 105. Verifying access group 107 represents one or more entities that desire to access and obtain verification data associated with an individual, which access to verification system 100 is through network 103.

Verification system 100 comprises a verification server 101 coupled to database 102. Verification server 101 provides an interface, through software, hardware or combination thereof, for registration of various types of users of the verification system 100 (e.g., academic institutions, employers, users associated with credential data, and users attempting to obtain verified information). Verification server 101 further provides an interface to receiving credential information, to provide data access and retrieval via database 102, and provide verification information related to obtained credential data. Verification server 101 further provides programs and/or applications that process retrieved credential data, provide secure communications, and provide for billing.

Verification server 101 might also provide for an analytics and suggestion engine. If a subscriber to the system searches for candidates with certain profiles, the system will analyze the search and provide the subscriber with similar individuals (if they chose to be searchable) to enhance search results and provide alternatives. Statistical information about candidate types, geographic concentrations, award concentrations, for example, might also be provided.

Verification server 101 is coupled to database 102 for storage and retrieval of credential data, which might further include scheduling software/applications that allow for periodic processing of credential data to cheek for regular satisfaction of maintenance of credentials (some embodiments might provide license expiration alerts to subscribers, i.e. when a license of a doctor is scheduled to expire in 90 days, 30 days, 7 days and the day before the employer will receive an alert via email or other chosen medium such as SMS).

Database 102 might be organized so as to separate academic, employment, professional membership, qualification certification, and other types of portions of credential data associated with a user for different forms of processing and different types of verification access by others. Database 102 might be implemented using traditional storage media (magnetic, electronic, optical, and so forth), but might also be cloud-based.

Operation of verification system 100 is described in more detail subsequently with respect FIGS. 4 through 6.

Although not shown in the FIG. 1, verification server 101 includes a security function that monitors various interfaces, such as those coupled to communication link 110, to ensure data integrity and security of information and operation of verification server 101 so that only authorized users might access functions within the system. As such, users must register with the system and be verified before actions are taken by verification server 101. Security methods might include, but are not limited to, machine-to-machine authentication i) at the time of registration with verification server 101 (device authentication) or ii) at the time of initiation of communication by users or entities previously registered (relationship authentication); and message authentication (through passing evidence to challenges) to verify identity of both parties during real-time message exchanges.

Network 103 generally illustrates various forms of communication methods, links, networks and systems that might be coupled in various ways to provide connectivity between verification server 101, database 102, credential entity 104, employment entity 105, user device 106, and verifying access group 107. Network 103 might be embodied in any of one or more forms of communications media known in the art, such as dedicated data networks, dial up service, cellular/wireless telephony and the like. As shown for the exemplary embodiments described herein, communication links are preferably enabled through the internet, where the protocol might be TCP and UDP. User device 106, operating either wired or wirelessly in FIG. 1, might also use TCP or UDP through its communication links.

Credential entity 104 represents an academic, trade, professional and/or corporate institution that bestows awards and degrees, organizational certifications and training, and/or other form of qualification, and this information that is associated with a user earning such qualifications is termed herein generally as credential data. Credential entity 104 registers with verification system 100 and provides credential data to verification system 100. Credential data i) includes specifics of qualifications earned, ii) is associated with a given individual, and ii) is information that is desirably verifiable by a third party, institution, organization and/or employer. Credential entity 104 might provide a credential verification device associated with the credential providing entity. When a user (e.g., corresponding to the individual that might be verified) processes the credential verification device and registers with verification system 100 through user device 106, such action might provide authorization for release of credential data considered private to the corresponding user. For some embodiments, the user will be able to define which credential, license, transcript etc. are made public and which are restricted. Once an item is restricted the user will be able to define who will see it either by allowing specific access to a user or by approving a system generated request by a third party (i.e. if an individual restricted their transcripts and an employer wishes to see them, the individual can either approve the employer's HR person by his email or the HR person might submit a request through the system to see the transcripts and once the individual approves it, the HR person receives an email with the link to the requested document. A more detailed description of the credential verification device is described subsequently with respect to FIG. 2.

Employment entity 105 represents past and present employers of an individual (e.g., generally corresponding to the user of user device 106). Employment entity registers with verification system 100 and provides various work experience and qualifications of an individual that are desirably verifiable by a third party, institution, organization and/or employer. The information provided by the Employment entity 105 is also considered to be a form of “credential data” for purposes herein,

User device 106, which is employed by a user that might be associated in some manner with one or more of credential entity 104 and employment entity 105, allows a user to read a credential verification device associated with the credential providing entities. User device 106 might preferably be enabled with a lap-top computer, tablet, smartphone, personal digital assistant (PDA) and the like. User device 106 might include i) a communication interface to enable communications and sense communication link parameters with and for various types of wired and wireless networks (e.g., network 103); ii) a processor to form messages, enable communications, control channel allocation and otherwise enable functions of the user device; iii) a code reader coupled to the processor to read and process information from a credential verification device associated with each credential providing entity; iv) a display and data entry interface; and y) location module, such as a global positioning system (GPS) module, coupled to the processor and able determine a geographic location of user device 106 about the Earth (as might be employed for security purposes to verify the user's identity, limit access to certain regions, and so forth). The code reader might typically be a camera and bar/QR code reader, but might also be embodied as a near field communication (NFC) device or radio frequency identification (RFID) tag reader. Thus, user device 106 causes communication with, provides read credential and verification device information to, and receives processed credential data from, verification system 100.

Verifying access group 107 represents one or more entities that desire to access and obtain verification data associated with a user. A member of verifying access group 107 registers with verification system 100 to verify aspects of credential data, such as institutions attended, degrees earned, various work experience and qualifications, professional memberships or qualifications, and/or current maintenance status of earned memberships or qualifications. Generally, members of verifying access group 107 verify aspects of credential data by requesting information and/or images as authentication data.

As previously described, verification server 101 includes a security function to ensure data integrity and security of information and operation of verification server 101 so that only authorized users might access functions within the system. In addition, for any documents received by verification server 101 and stored in database 102, each document recorded in the system corresponding to individual/users, will automatically be assigned a watermark. Such watermark might be a visible watermark on the image of the document, but might also include an “invisible” watermark that can be source-verified. Such watermarking techniques are well-known to one skilled in the art of image and video processing. For some embodiments, the watermark is displayed revolving around the image in 3D avoiding the use of a “print screen” to bypass the security feature. The watermark might also include a date and time stamp that, if someone does copy the image, the security provided by the date and time stamp applies as well.

FIG. 2 shows an exemplary credential award 200, including physical embodiment of credential 201 and credential verification device 202, as might be employed by the exemplary embodiment of FIG. 1. Credential verification device 202 includes coded information (“code”) 203. Credential verification device 202 forms a unique and individualized physical “carrier” for code 203. Code 203 represents a securely coded form of information that can be scanned or otherwise read. For example, code 203 might be information stored in a bar code, QR code and the like printed on a label, but might also be information stored in an NFC or RFID tag. The information in code 203 is at least partially securely encoded, and allows, for example, a reader to obtain a subset of the information including a universal resource locator (URL) to direct a browser to login to verification system 100. Securely encoded portions of the information might allow for verification system 100 to verify that the credential verification device 202 is authorized for use by the system, and identify the particular credential entity to verification system 100. Other embodiments might allow for other form of direct or dial-up login. The physical embodiment of credential 201, such as a diploma, might be awarded to the individual, along with credential verification device 200. Also, in for mobile applications, an employer might be able to use their camera to scan system generated. QR code that are embedded by the user in their resume and thus authenticate certain credentials and employment history directly from their resumes,

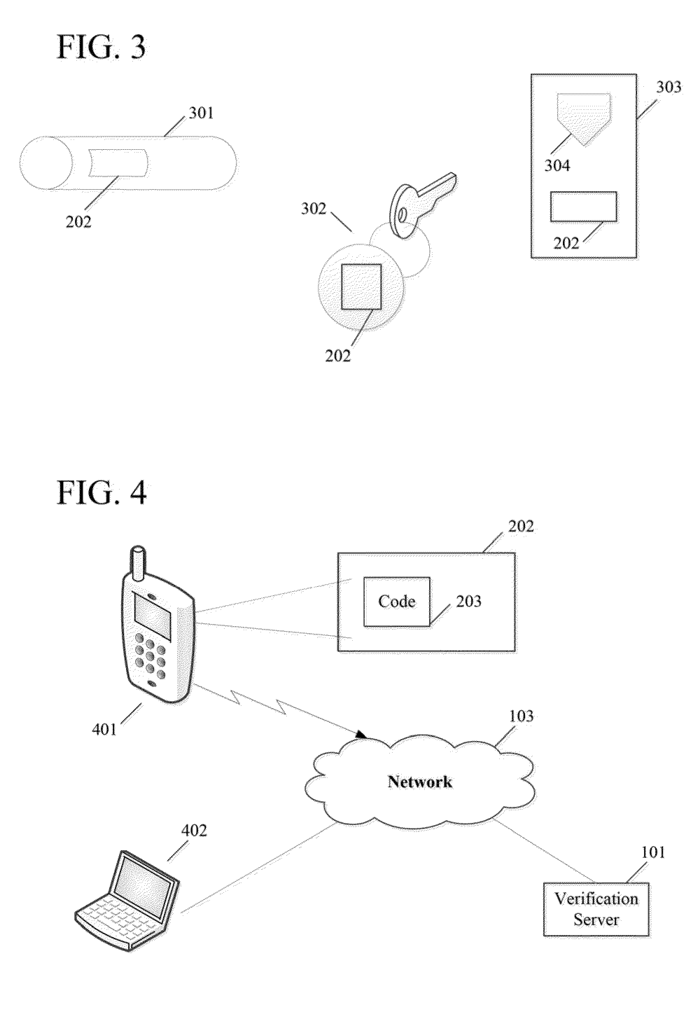

FIG. 3 shows alternative embodiments of exemplary credential verification devices. Diploma tube 301 includes credential verification device 202 embodied as a label affixed to the exterior of the tube or the back of the diploma. Key chain 302 includes credential verification device 202 embodied as a decorative bar code, QR, code, NFC or RFID tag included in the lanyard fob of the keychain. Unique and individualized card 303 includes credential verification device 202. embodied as a decorative bar or QR code affixed to the card, and includes decorative device 304 representing an Institutional seal, such as a University shield or professional group logo. Unique and individualized card 303 might be formed as a “coin”, popular as a collectible. Various embodiments 301, 302 and 303 illustrate that the preferred embodiments include credential verification device 202 that is generally integrated with a form of sales or marketing device to provide for easy use and general acceptance of use for the credential verification device 202.

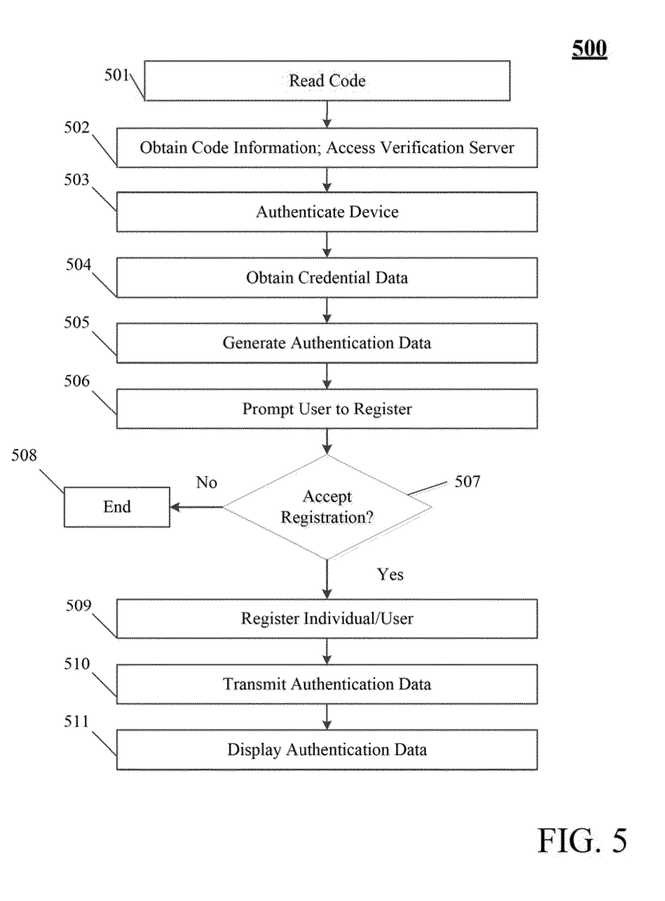

FIGS. 4 and 5 show exemplary communication by an individual as user to verification system 100 of FIG. 1. For illustration, user device 106 is shown as both a smartphone 401 and laptop computer 402. Upon receiving an award with credential verification device 202, the individual scans or otherwise reads code 203 with smartphone 401 at step 501. Reading code 203 with smartphone 401 obtains a subset of the information including a universal resource locator (URL) to direct a browser to login to verification server 101 via network 103 at step 502. An application (e.g., browser) launches to connect the smartphone 401 to verification server 101, and verification server 101 first authenticates the coded information corresponding to credential verification device 202 at step 503. Verification server 101 then obtains credential data from database 102 corresponding to the individual and the credential verification device 202 at step 504, and generates authentication data from the credential data at step 505. Authentication data might be a digital, verified image of a diploma, degree, or transcript, but the present invention is not limited thereto. Verification server 101 then prompts the user to create an account with verification system 100 at step 506. A test then determines if the user accepts registration and so wants create an account with verification system 100 at step 507. If the user declines to create an account, the process terminates at step 508. If the user accepts to create an account, the process allows the user to create an account in the name of the individual, thereby registering the individual, at step 509. Alternatively, a user will be able to create an account without an award using his own personal email account and then link received awards to his account thus only having one account linked to multiple awards. Verification server 101 then transmits authentication data to smartphone 401 at step 510. Authentication data is presented via a display on smartphone 401 at step 511.

Verification system 100 supports several instances of authenticating the receipt (present and past) of credential awards, certifications, and other accompanying documents (the “Award”). For example, for academic credential data, or “seals” awarded to an individual, these instances might be divided into three forms: new seal, post seal, and transcript seal. A new seal registration corresponds to when an Award is received by an individual (the “Awardee”). In addition to the physical Award, the Awardee receives from the Award provider (credential entity) a unique and individualized card as the credential verification device (or email, and if so skip the card scanning part and go directly to user authentication via email) that allows for the online verification process to take place. The individual scans the code on the unique and individualized card with a smartphone (as described above with respect to FIGS. 4 and 5), and an application (e.g., browser) launches to connect the individual to verification system 100.

This process includes creating an individual account for the Awardee, verifying their identity through the institution granting the award and facilitating the secured display of the Award online. A post seal registration corresponds to when an Alumni or other past Awardees who did not previously register with the verification system desires or otherwise needs an online seal of their Award. The Alumni or past Awardee might communicate, directly with the verification system through the Internet with a browser on laptop computer 402 and either i) directly register, or ii) request a unique and individualized card to follow the process outlined for the new seal instance previously described. A transcript seal registration is a subset of the new and post seal examples, which provides the Awardee with the ability to communicate directly with the verification system through the Internet with a browser on a lap-top computer and have verified transcripts (or other Award details) presented to third parties requesting it without complete registration with verification system 100.

In some embodiments, if for example the user approaches a company for a position that he wants to apply for the user might provide their resume. The company (or individual therefrom) accesses verification system 100 and searches for the user by an identifier such as the user's email address. The user will get a notification that the company is seeking the user's verified credentials and will be asked to approve access by the company. The user will be able to approve access on a per Award basis (Diploma, transcripts, sports awards, and the like) or provide complete access to die company searching for the user's information. Once approved, the company will receive an email with a link to the user's awards. Users in the system will be able to set up their visibility at the following levels: for example, available to all, only name available, some information available (user will choose) or nothing viewable to anyone. This allows the user full control over who can and cannot view the information at all times.

In addition to new and post seals, the verification system 100 might also provide seal detail and seal expiration/validity. Seal detail is an add-on to both new and post seals, and gives the Awardee the option to have transcripts, race results or other pertinent information attached to an Awardee's digitized Award. The Awardee might be able to select which details are displayed and can grant access to third parties requesting it. For seal expiration/validity, the verification system 100 retrieves third party information regarding credential expiration date that is constantly cross checked against our internal database for accuracy and allows for reporting and alerts to the user and other subscribers to the system (as long as they have the user's permission).

For some embodiments, when a user creates an account, the user might be asked to record a personal message. Once the user logs into the verification system website with the proper two factor authentication solution they can hear their own personal message, providing the user with assurance that the login is to the right site and is not at a fake site. In addition, once the user inputs their username and password, the verification system will ask them to speak their passkey. The verification system will then analyze both the spoken word and the voice and will allow or disallow access accordingly.

Once an individual has created an account, such action authorizes verification system 100 to provide verification data to members of verifying access group 107. Verification data might include verified and secure images of degrees, awards and transcripts, but might also include employment history data with a mark of verification and approval from the employer. In some embodiments, the individual might create different classes of credential data, such as education credentials, membership credentials, employment credentials, and so forth, The individual might then limit permission for different members (“member types”) of verifying access group 107 to receive only certain authentication data generated from the individual's credential data. For example, an employer might want to know degrees earned and professional memberships of the individual, but the individual might want to keep membership in certain political organizations private. In such case, a potential employer might fall into a specific member type only be granted permission for classes of credential data corresponding to academic degrees/awards, post-graduate training qualifications, and professional memberships.

Other embodiments might allow for verification server 101 to generate a secure access code assigned to an individual. While this might be a login number, it might also include a bar or QR code that the individual provides to third parties. A member of verifying access group 107 simply inputs the login number or reads the code, and the member is directed to verification system 100 in a process analogous to that described above with respect to FIGS. 4 and 5. Verification system 100, in turn, then provides authentication data to the member. For example, verification server 101 generates a QR code as the secure access code for an individual, and the individual then affixes the QR code on their resume. Employers receiving the individual's resume need only automatically scan the resume and receive a complete set of verified academic, employment and professional qualifications from which to evaluate the individual for a job position.

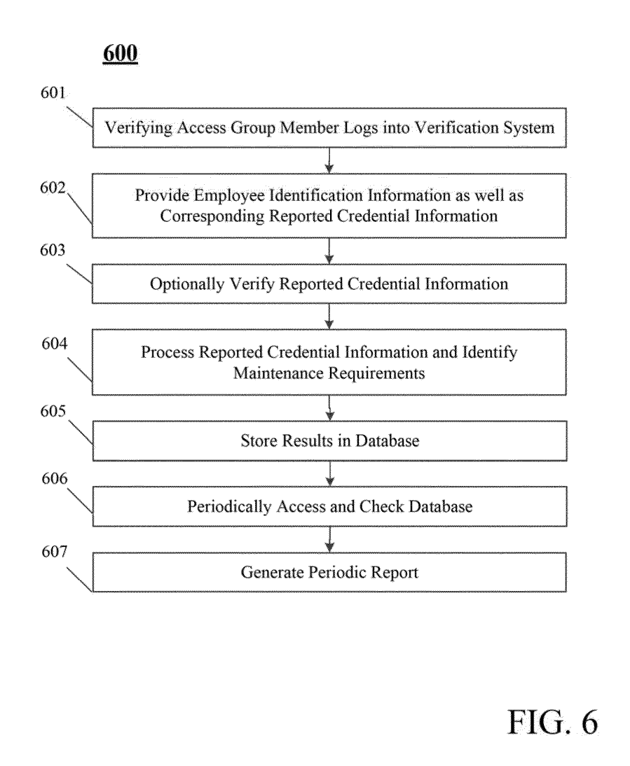

FIG. 6 shows a method of populating a database and tracking renewal of verification data as might be employed by the verification system of FIG. 1. A member of verifying access group 107 might be an organization that employs one or more individuals who, in addition to obtaining certain credentials, must also maintain certain credentials. For example, a doctor or medical technician might need to periodically be re-certified in certain types of care. The member registers and/or logs into verification system 100 at step 601. At step 602, the member inputs identification information for each employed individual, and also inputs reported credential information for each employed individual. Alternatively, at step 602, each of the employed individuals separately registers or otherwise logs in as described previously with respect to FIGS. 4 and 5, and the employed individual provides the reported credential information. The information also might be extracted directly from the licensing authorities by scraping public websites and establishing direct access to their system to retrieve the information directly. Optionally, at step 603, the reported credential information for each employed individual is verified by verification system 100. At step 604, verification server 101 processes the reported credential information and identifies those specific credentials or qualifications that require maintenance action by either i) the member or ii) the employed individual. At step 605, the processed, reported credential information is stored in database 102, along with due dates, compliance dates, course requirements, and the like for specific credentials or qualifications associated with each corresponding employed individual. At step 606, verification server 101 periodically accesses and checks the processed, reported credential information for upcoming due dates for maintenance action. At step 607, verification server 101 periodically reports to the member (and the user) any upcoming, overdue or unfulfilled maintenance actions by either i) the member or ii) the employed individual. Another aspect of the system is that the employer, university and other awarding institutions might provide the verification system with the user's picture, thus enabling authentication of the user's image for future employers and other third parties.

When a member of verifying access group 107 requests authentication data, only certain authenticated information is generated from the individual's credential data from corresponding portions of the verified digital information in the database. The authentication data is generated in a secure format; providing the requested, authentication data relating to the individual by the verification server for display.

Since the present embodiments provide a secure system for verification, security aspects of the verification system itself are important. Preferred embodiments of the platform are hosted in a secure hosting environment and supports SSL (HTTPS). Additional security features, such as two or three factor authentication, VPN and other similar measures, might allow the Awarding institutions to have as higher level of reliance on the security of the information they provide. Complete Multi-Layer, and Defense-In-Depth Security might be provided, including: Complete Physical and Logical Separation of all Customer/consumer data and applications; Data Loss Prevention at all layers (Data-at-Rest, Data-in-Motion, Active Content-Filtering); Intrusion Detection/Intrusion Prevention Systems; Next-Generation Firewalls and DPI; Anti-Malware/Spyware/Virus/etc.; Full Data Encryption (At-Rest, In-motion, Storage); Database Security: Data Encryption, Transaction-Layer Security, Audit Trail; Cloud-Integrated Analysis and Audit of Defensive Posture 24×7×365; and complete Backup and Recovery with multi-site recovery and failover. Enhanced end-user security might include: SmartCard/User-Certificate level Authentication (CAC and PIV card enabled—For U.S. Federal and DoD); FIPS-140-X Certified Encryption for and on all components; DoD STIG/SCAP 365-day auditing and compliance; All systems NIACAP/DITSCAP C&A Certified and Accredited Systems; and SCIF'd environments for Classified Customers.

Security might also be provided for in three distinct areas: Database/Web application layer security, network layer security, and partner layer security. : Database/Web application layer security includes all data within the database encrypted using U.S. Government approved FIPS-140 encryption algorithms such as AES512-bit encryption. Database focused security watch for application-layer attacks into the DB itself. All database transactions are audited and logged and fed to various Security Information monitoring systems for constant analysis. User-level 2-factor authentication all the way down to the user's own data and objects stored and encrypted in the DB. Database object-level encryption and security is employed to ensure data protection for user information. Web servers and portals will also employ the same multi-factor authentication as well as employ various web application, session, and server-level protection against application-layer attacks.

Network layer security includes: Intrusion Detection/Intrusion Prevention Systems; Next-Generation Firewalls and Deep Packet Inspection (DPI) and anlysis and Anti-Malware/Spyware/Virus/etc. Partner layer security (e.g., security for credential entity 104, employment entity 105, user device 106, and verifying access group 107 of FIG. 1) includes external and (partner approved) internal security audit. The operators of the verification system and its partners might implement a tightly focused connection/network scheme to ensure all communications are FIPS-140 encrypted, have multi-layers of defense-in-depth Network and Host-level security such that connections can be traced back to the individual user or system initiating and completing the transaction and that no data leakage or compromise was possible during any transactions.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, DVDs, Blu-Ray disks, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary; Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

As used herein in reference to an element and a standard, the term “compatible” means that the element communicates with other elements in a manner wholly or partially specified by the standard, and would be recognized by other elements as sufficiently capable of communicating with the other elements M the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

Further, the term “comprises or includes” and/or “comprising or including” used in the document means that one or more other components, steps, operation and/or existence or addition of elements are not excluded in addition to the described components, steps, operation and/or elements.

Also, for purposes of this description, it is understood that all gates are powered from a fixed-voltage power domain (or domains) and ground unless shown otherwise. Accordingly, all digital signals generally have voltages that range from approximately ground potential to that of one of the power domains and transition (slew) quickly. However and unless stated otherwise, ground may be considered a power source having a voltage of approximately zero volts, and a power source having any desired voltage may be substituted for ground. Therefore, all gates may be powered by at least two power sources, with the attendant digital signals therefrom having voltages that range between the approximate voltages of the power sources.

No claim element herein is to be construed under the provisions of 35 U.S.C. §1.12, sixth paragraph, unless the element is expressly recited using the phrase “means for” or “step for.”

It is understood that various changes in the details, materials, and arrangements of the parts which have been described and illustrated in order to explain the nature of this invention may be made by those skilled in the art without departing from the scope of the embodiments of the invention as encompassed in the following claims.

We claim:

1. A method of providing verified digital information, the verified digital information relating to individual credential data, the method comprising:
communicating, by a verification server, with at least one entity through a network, receiving credential information for a plurality of individuals, and storing the credential data in a database;
registering an account for at least one individual of the plurality of individuals through an associated user device;
processing the credential data to form verified digital information;
receiving, by the verification server, a request for authentication data relating to an individual,
generating the requested, authentication data relating to the individual by the verification server from corresponding portions of the verified digital information in the database, the authentication data generated in a secure format;
providing the requested, authentication data relating to the individual by the verification server for display.

2. The invention of claim 1, wherein, when the requested authentication data is an image of a document, the providing for display provides the image having a watermark.

3. The invention of claim 1, wherein the user device is at least one of a physical device and a virtual device, and a user of the user device creates an account corresponding to one of the plurality of individuals.

4. The invention of claim 3, wherein, if the user device is a virtual device, the registering comprising registering the account through at least one of a user login and a user e-mail provided by the verification server.

5. The invention of claim 3, wherein if the user device is a physical device, the registering comprising registering the account through reading a code associated with the user device from a credential verification device.

6. The invention of claim 5, wherein the code associated with the credential verification device is read from at least one of a bar code, QR code, near field communication (NFC) device or radio frequency identification (RFID) tag.

7. The invention of claim 1, wherein the authentication data relating to individual is provided by the verification server to a member of a verifying access group via a display device.

8. The invention of claim 7, wherein the requested authentication data is an image of a document, the providing for display provides the image having a watermark.

9. The invention of claim 1, wherein the credential data i) includes specifics of qualifications earned and employment history, ii) is associated with a given individual, and ii) is information that is verifiable by at least one of a third party, institution, organization and employer.

10. The invention of claim 9, wherein the credential data includes qualifications to perform various Duties/job functions that arise from academic, professional, and trade institution awards and degrees, organizational certifications and training, and work experience.

11. The invention of claim 1, wherein the entity is at least one of a credential entity and an employment entity.

12. A verification system, the system comprising:
a verification server coupled to at least one entity through a network, and is configured to receive credential information for a plurality of individuals; and
a database coupled to the verification server adapted to store the credential data and provide verified digital information,
wherein the verification server is configured to register an account for at least one individual of the plurality of individuals through an associated user device, and
wherein the verification server is configured i) to process the credential data to form verified digital information; and ii) to generate, from a received request, authentication data relating to the individual by the verification server from corresponding portions of the verified digital information in the database, the authentication data generated in a secure format.

13. The invention of claim 12, wherein the verification server is configured to provide the requested, authentication data relating to the individual by the verification server for display.

14. The invention of claim 13, wherein the verification server provides the requested, authentication data relating to the individual as a secure image.

15. The invention of claim 12, wherein the verification server is configured to transmit at least one of a text and an e-mail to a subscriber generating the request, and provides the requested, authentication data relating to the individual based on a response to the at least one of a text and an e-mail.

16. A credential verification device for use with a verification system, the credential verification device comprising:
a physical carrier;
a code affixed to the physical carrier, the code associated with an individual, a verification System, and at least one of a credential entity and an employment entity;
wherein a user device, configured to read the credential verification device, reads the code and is configured to access a verification server of the verification system.
wherein the verification server is coupled to at least one entity through a network, and is configured to i) receive credential information for a plurality of individuals, and ii) to store the credential data in a database; and
wherein the verification server is configured to provide requested, authentication data relating to each individual from the credential data in a database.

17. The invention of claim 16, wherein the physical carrier of the credential verification device is at least one of lanyard fob, a card, a label, a coin, and a sales/marketing device.

18. The invention of claim 16, wherein the code associated with the credential verification device is at least one of a bar code, QR code, near field communication (NFC) device or radio frequency identification (RFID) tag.

19. A non-transitory machine-readable storage medium, having encoded thereon program code, wherein, when the program code is executed by a machine, the machine implements a method for providing verified digital information, the verified digital information relating to individual credential data, comprising the steps of:
communicating, by a verification server, with at least one entity through a network, receiving credential information for a plurality of individuals, and storing the credential data in a database;
registering an account for at least one individual of the plurality of individuals through an associated user device;
processing the credential data to form verified digital information;
receiving, by the verification server, a request for authentication data relating to an individual,
generating the requested, authentication data relating to the individual by the verification server from corresponding portions of the verified digital information in the database, the authentication data generated in a secure format;
providing the requested, authentication data relating to the individual by the verification server for display.

20. The invention of claim 19, wherein, when the requested authentication data is an image of a document, the providing for display provides the image having a watermark.
